(19) United States
(12) Patent Application Publication
(10) Pub. No.: US 2023/0204159 A1
(43) Pub. Date: Jun. 29, 2023

(54) HYDROGEN REFUELING SYSTEM AND METHOD OF HYDROGEN REFUELING

(71) Applicant: L'AIR LIQUIDE SOCIETE ANONYME POUR L'ETUDE ET L'EXPLOITATION DES PROCEDES GEORGES CLAUDE, Paris (FR)

(72) Inventors: Etienne WERLEN, Tokyo (JP); Thibaut FRANCOIS, Sassenage (FR)

(73) Assignee: L'AIR LIQUIDE SOCIETE ANONYME POUR L'ETUDE ET L'EXPLOITATION DES PROCEDES GEORGES CLAUDE, Paris (FR)

(21) Appl. No.: 16/635,668

(22) PCT Filed: Jul. 31, 2017
(86) PCT No.: PCT/JP2017/027679

§ 371 Date: Jan. 31, 2020

(51) Int. Cl. F17C 13/02; F17C 7/02; F17C 5/00

(52) U.S. Cl. CPC F17C 13/025; F17C 7/02; F17C 5/007; F17C 2205/0323; F17C 2205/0376; F17C 2221/012; F17C 2223/035; F17C 2227/0157; F17C 2250/0626; F17C 2227/0341; F17C 2250/01; F17C 2250/032; F17C 2250/043; F17C 2265/065

(57) ABSTRACT

This invention can provide a hydrogen refueling system capable to reduce waiting time for refueling H₂ to vehicles. The system is designed and operated to acquire the residual pressure in the vehicle the that connects to the dispenser, then to calculate sufficient conditions to perform complete refueling of the connected vehicle (in particular minimum pressure in buffers), and then to start H₂ transfer to the vehicle as soon as the conditions are met. Waiting time can be further reduced with minimum investment by having a H₂ dispenser with two H₂ refueling hoses which has only one H₂ flow control valve and/or only one H₂ cooling heat exchanger and/or only one H₂ flow metering system.

### CROSS-REFERENCE TO RELATED APPLICATIONS

This application is a § 371 of International PCT Application PCT/JP2017/027679, filed Jul. 31, 2017.

### BACKGROUND

### Field of the Invention

The present invention relates to a hydrogen refueling system, for example a hydrogen refueling station (HRS).

### Related Art

In hydrogen refueling stations (HRS), which purpose is to refuel Fuel Cell Vehicles (FCV) (512, 518) with hydrogen, a dispenser (505) is typically equipped with one hose (510), sometimes two hoses (typically one for refueling at 35 MPa and one for refueling at 70 MPa) as shown FIG. 5A and 5B. Also, in order to comply with current refueling protocols and achieve fast refueling of FCV (typical target is 5 kg within 3 minutes or according to the SAE J 2601), some high pressure (HP) buffer bank(s) (504) are installed upstream the dispenser (505) to provide high H₂ flow rate during refueling. The HP buffer bank(s) (4) need to be filled at a minimum pressure before to start refueling in order to follow the pressure ramp specified by the refueling protocol and to achieve successful refueling.

HRS are typically equipped only with one dispenser (505). However, some peak load hours exist where several FCVs (512, 518) will come within a short period of time.

When one FCV (518) is queuing, the typical sequence is as follows.

Upon termination of refueling of the first FCV (512), customer or operator has to disconnect the nozzle (511) and place it back on the dispenser (505).

First FCV (512) customer has to proceed to payment.

First FCV (512) is moved out of the dispenser (505) area.

Second FCV (518) can move in front of the dispenser (505).

Second FCV (518) customer initiates payment by card (if applicable).

Customer or operator connects the refueling nozzle (511) to the second FCV (518).

If HP buffers (504) have not yet been refilled to the target pressure, customer has to wait for the end of HP buffers (504) refilling.

Customer or operator can press the start button. After pressing the start button, it makes to launch the connection leak test and to begin refueling.

Typically, this complete sequence between the end of H₂ transfer to the first FCV (512) to the beginning of H₂ transfer to the second FCV (518)can take 3 minutes or more.

Also, HP buffer(s) (504) refilling target pressure is a fixed value predefined to achieve successful refueling of a FCV (512, 518) having a tank (513, 519) almost empty. As a consequence, a customer may wait for the HP buffer(s) (504) to be refilled up to target pressure, even though his tank has significant remaining pressure, and successful refueling could be achieved with lower target pressure(s). In addition, pre-cooling power may be sized by considering some interval between two FCV (512, 518) refueling and some timer may need to be elapsed before authorizing refueling of the next FCV (518). As a consequence, a customer may wait for the re-accumulation of enough cold to perform refueling of a tank almost empty even though his tank (519) has significant remaining pressure, and successful refueling could be achieved with shorter delay.

Document D1, JP2015190596 A1, discloses that the determining unit determines the number of vehicles which is capable of refueling with H₂ within a prescribed time based on the acquired pressure in the accumulator, and determines the waiting time of the vehicle for refueling based on the filling time required for filling the accumulator with hydrogen using the hydrogen stored in the accumulator and the sum of the number of vehicles that are refueling H2 by the dispenser and the number of vehicles that are waiting for refueling H2 by the dispenser. And the paragraph [0043] in this document disclose that since the remaining pressure in the tank of the vehicles that are waiting for refueling H2 is unknown, the specified period of time (for example 5 minutes) for refueling process is required.

Document D2, U.S. Pat. No. 6,901,302 B1, discloses some network communication with a fleet of vehicles circulating in view of anticipating the load of HRS (i.e. producing the appropriate quantity of H2 to refuel the vehicles). And this document discloses the transmission of remaining quantity or remaining pressure in the vehicle to the station (HRS) for controlling the station load in view of filling time.

### SUMMARY OF THE INVENTION

In the prior art system of FIGS. 3 to 4, since the next vehicle can move to the dispenser and connect refueling hose only after previous vehicle has gone away, some operations other than actual H₂ transfer to vehicle tank, such as payment completion process, car moving time, initiation payment process, etc., must be counted as waiting time for the next vehicle.

The document 1 only disclose about the improvement the user's convenience by calculating and displaying the waiting time of the vehicle based on the states such as the number of vehicles being filled, the number of waiting vehicles, the pressure in the accumulator, and H2 filling time to the accumulator.

The document 2 only disclose that configured to receive amount of H2 in the tank from a vehicle that is traveling to HRS, to compare with the amount of hydrogen stock in HRS and to judge the excess/deficiency level, to operate the hydrogen generator according to the excess/deficiency level and to keep the hydrogen stock.

Therefore, the prior art system of FIGS. 3 to 4, D1 and D2 don't reduce the waiting time of the next vehicle in one dispenser.

The purpose of this patent is to describe solutions to minimize customer waiting time with keeping only one dispenser (5) at HRS, or having pieces of equipment shared by two dispensers (5). This invention can provide a hydrogen refueling system capable to reduce a waiting time for refueling H₂ to the vehicle.

As first invention, a hydrogen refueling system includes as main design characteristic to have a H₂ dispensing system (dispenser) with two H₂ refueling hoses which has only one H₂ flow control valve and/or only one H₂ cooling heat exchanger and/or only one H₂ flow metering system.

As first invention, the hydrogen refueling system including:

at least one H₂ supply source(1) that stores H₂ which has a first pressure;

compressor(2) that is able to increase H₂ pressure and which can transfer H₂ from one container(e.g. MP buffer(3)) or H₂ supply source(1) to another(e.g. MP buffer(3), HP buffer bank(s)(4a, 4b, 4c));

one or several HP buffer bank(s)(4a, 4b, 4c) that store H₂ under various pressures or same pressure (various predetermined pressures or same predetermined pressure), generally higher than pressure of the H₂ supply source(1);

optionally, one (or more) MP buffer (3(3a, 3b, 3c)) that store H₂ under a pressure (a predetermined pressure), generally higher than pressure of the H₂ supply source (1) and generally lower than the pressure of HP buffer bank(s)(4a, 4b, 4c);

at least one dispenser (5), which can transfer and discharge H₂ from at least one container (e.g. H₂ supply source(1), MP buffer(3), HP buffer bank(s)(4a, 4b, 4c)) and/or from compressor (2) discharge into the tank (13, 19) of a vehicle;

optionally, one heat exchanger (8), which can cool down H₂ before being transferred to the tank(13, 19) of a vehicle and which is fed with a cooling fluid;

first controller(30) that controls the compressor(2) and one or more valve(s)(e.g. 40, 41a, 41b, 41a, 43a, 44a) placed on pipe(s)(i.e. 50, 52, 53, 54a, 55a, 56a) in such a way that, when the station is idle (i.e. no vehicle is refueled or is waiting), depending on pre-determined operation steps, H₂ is transferred from one container (1, 3(3a, 3b, 3c), 4a, 4b, 4c) to another, up to pre-determined target pressure value(s) (Pₛₑₜ) in recipient container(s) (3(3a, 3b, 3c), 4a, 4b, 4c), for example, in the case there is one MP buffer (3), in one operation step controlled by first controller, H₂ is transferred from H₂ supply source(1) to MP buffer (3) through the compressor (2) until the pressure in MP buffer (3) reaches a pre-determined target pressure which is higher than the pressure of the H₂ supply source(1), and in other operation steps controlled by first controller (30), H₂ is transferred from MP buffer (3) to one HP buffer bank(s) (4a, 4b, 4c) through the compressor (2) until the pressure in HP buffer banks(s) (4a, 4b, 4c) reaches a pre-determined target pressure which is higher than the pressure in MP buffer (3);

data processor (35) that, when one vehicle (12,18) is connected to be re-fueled, reads the residual pressure in the tank (13, 19) of the vehicle (12,18), using nozzle (11, 17) IR communication device or pressure sensor (14, 20) and, depending on the residual pressure in vehicle tank (13, 19), depending on pressure in the containers (1, 3(3a, 3b, 3c), 4a, 4b, 4c) and depending on ambient temperature, calculates target pressure value(s) (TP) in one or several containers (1, 3(3a, 3b, 3c), 4a, 4b, 4c) optimized to be sufficient to achieve complete refueling of connected vehicle (12,18).

In case one heat exchanger (8) is present, data processor (35) may as well calculate, depending on the residual pressure in vehicle tank, depending on quantity of H₂ refueled in previous vehicle(s) and depending on ambient temperature, the sufficient conditions to achieve refueling of connected vehicle according to low H₂ temperature refueling protocol, such as minimum time interval with previous vehicle or maximum temperature of the heat exchanger (8).

The hydrogen refueling system further includes:

second controller(40) that, when one vehicle (12,18) is connected to be re-fueled, may use the conditions calculated by data processor (35) to decide and execute an optimized sequence that controls the compressor (2) and valves to reach target pressure value(s) (TP) in the container(s) (3(3a, 3b, 3c), 4a, 4b, 4c) calculated by the data processor (35).

In the hydrogen refueling system,

the optimized sequence is decided in such a way that the time for being able to reach the conditions calculated by the data processor (35) after connecting a refueling nozzle(11, 17) to the vehicle is a minimum time. This minimum time is zero when sufficient conditions to achieve complete refueling of connected vehicle are already met when the refueling nozzle(11, 17) is connected to the vehicle.

The hydrogen refueling system further includes:

third controller(45) that, when the conditions calculated by data processor (35) are met, controls the compressor (2) and valve(s)(e.g. 40, 41a, 41b, 41a, 42b, 43a, 43b, 44a, 44b, 6, 9, 15) according to a pre-determined strategy and filling protocol, in such a way that H₂ is transferred from at least one container (1, 3(3a, 3b, 3c), 4a, 4b, 4c) to the tank of the vehicle.

The first controller(30)and second controller (40) may control one or more valve(s)(e.g. 40, 41a, 41b, 41a, 43a, 44a) which is(are) placed on pipe(s)(e.g. 50, 52, 53, 54a, 55a, 56a) in order to transfer H₂ from one container (1, 3, 4a, 4b, 4c) to another, either directly or through the compressor(2).

Target pressure value(s)(TP) in the container(s) (3(3a, 3b, 3c), 4a, 4b, 4c) calculated by the data processor (35) may be lower than the pre-determined target pressure value(s)(Pₛₑₜ) in recipient container(s) (3, 4a, 4b, 4c) used by first controller (30). In addition, target pressure values(TP) in HP buffer banks(4a, 4b, 4c) calculated by the data processor (35) may be the same value for all HP buffer banks or different values.

Based on a container order(e.g. HP buffer bank (4a), then HP buffer bank (4b), then HP buffer bank (4c)) that may be calculated depending on remaining pressure in the containers (1, 3, 4a, 4b, 4c), the third controller(45) may control valves (e.g. 40, 41a, 42a, 42b, 43a, 43b, 44a, 44b, 6, 9, 15) to connect one of the containers (1, 3, 4a, 4b, 4c) to the FCV tank(13, 19) and then to refuel H₂ into the FCV tank by balancing pressures between the connected container and the FCV tank (13, 19), and then, after disconnecting the used container, to connect another of the containers (1, 3, 4a, 4b, 4c) to the FCV tank (13, 19) and then to refuel H₂ into the FCV tank (13, 19) by balancing pressures between the connected container and the FCV tank (13, 19). And then, the sequence may be repeated with other containers (1, 3, 4a, 4b, 4c), depending on a pre-defined strategy. For example, the containers order may be calculated to connect first the container having the lowest remaining pressure, and then follow the order of increasing remaining pressure in the containers used to refuel H₂.

When refueling H₂ into the FCV tank (13, 19) by switching between containers, balancing pressures between the connected container and the FCV tank (13, 19) may be partial. Changing to the next container may be made when there is still a large pressure difference between the connected container (1, 3, 4a, 4b, 4c) and the FCV tank (13, 19), for example when the refueling flow rate required by fueling protocol cannot be maintained, due to the flow restrictions between the connected container (1, 3, 4a, 4b, 4c) and the FCV tank (13, 19).

In case that there are two or more MP buffers (3(3a 3b 3c)), the pre-determined target pressure value may be the same value for all MP buffers or different values.

In case that there are two or more HP buffer banks(4a, 4b, 4c), the pre-determined target pressure value may be the same value for all HP banks or different values.

As the first invention,

the at least one of dispenser(5) may include,

a control valve(6) that is placed on a main line (57) through which is sent the H₂ from the containers (1, 3, 4a, 4b, 4c);

a metering device(7) that is placed downstream the control valve (6) on the main line (57);

a heat exchanger(8) that is placed downstream the metering device(7) on the main line (57) and cools or warms the H₂ through the main line (57);

first and second branch lines (57a, 57b) that are branched from the main line (57) downstream the heat exchanger(8);

first on-off valve(9) that is placed on the first branch line (57a);

second on-off valve(15) that is placed on the second branch line (57b);

first hose(10) that has a first refueling nozzle(11) at its one end part and is connected the first branch line (57a) at its another end part; and

second hose(16) that has a second refueling nozzle(17) at its one end part and is connected the second branch line (57b) at its another end part.

In the first invention,

the at least one of dispenser(5) may include,

first and second interface (21, 22);

the first interface (21) may include first payment interface, first ticket system, and first metering display;

the second interface(22) may include second payment interface, second ticket system, and second metering display.

In the first invention,

the third controller(45) may control first refueling process which is configured to refuel the H₂ through the first hose(10) from the first refueling nozzle(11) into first FCV tank(13) of first vehicle(12), and/or

the third controller(45) may control second refueling process which is configured to refuel the H₂ through the second hose(16) from the second refueling nozzle(17) into second FCV tank(19) of second vehicle(18);

in case of a first refueling process,

the data processor(35) may acquire first residual pressure of the first FCV tank(13) which is connected with the first refueling nozzle(11) and may calculate sufficient conditions to achieve complete refueling of first vehicle (12);

second controller(40) may use the conditions calculated by data processor (35) to decide and execute an optimized sequence that controls the compressor (2) and valves to reach within a minimum time the target pressure value(s)(TP) in the container(s) (1, 3, 4a, 4b, 4c) calculated by the data processor (35);
when the conditions calculated by data processor (35) are met and provided that H₂ transfer with second nozzle (17) is already finished, third controller (45) may proceed with refueling of first vehicle (12);

in case of the second refueling process,

the data processor (35) may acquire second residual pressure of the second FCV tank (19) which is connected with the second refueling nozzle (17) and calculate sufficient conditions to achieve complete refueling of second vehicle (18);

second controller(40) may use the conditions calculated by data processor (35) to decide and execute an optimized sequence that controls the compressor (2) and valves to reach within a minimum time the target pressure value(s) (TP) in the container(s) (1, 3, 4a, 4b, 4c) calculated by the data processor (35);
when H₂ transfer with first nozzle (11) is finished, transfer of H2 with first nozzle (11) is finished and when the conditions calculated by data processor (35) are met, third controller (45) may proceed with refueling of second vehicle (18).

In the first invention, the first residual pressure may be measured by first pressure sensor(14) which is placed downstream the first on-off valve(9) on the first branch line (57a), and/or

the second residual pressure may be measured by second pressure sensor(20) which is placed downstream the second on-off valve(15) on the second branch line (57b).

In the first invention, the third controller(45) may control temperature and/or flow rate of cooling fluid which is sent to the heat exchanger(8) to control temperature of the H₂ which is refueled into the FCV tank.

In the first invention, the second controller(40) may calculate an expected waiting time which is period for being able to start refueling process from after completing payment initiation or after connecting the nozzle to the first or second FCV tank and output the expected waiting time to output device; and/or

the second controller(40) may calculate an expected complete time which is period for completing refueling process from after completing payment initiation or after connecting the nozzle to the first or second FCV tank and output the expected complete time to output device.

In the first invention, the dispenser(5) includes two H₂ refueling hoses (10, 16), only one H₂ flow control valve (6) and/or only one H₂ cooling heat exchanger (8) and/or only one H₂ flow metering system (7).

Second invention is a method for operating refueling process, the refueling process is under the condition that two vehicles can be connected at the same time to the H₂ dispensing system and refueling of the second vehicle is started as soon as transfer of H₂ to the first vehicle is finished and conditions calculated by the data processor (35) are met.

As second invention, the method for performing first refueling process which refuels H₂ to first FCV tank(13) of first vehicle(12) and second refueling process which refuels H₂ to second FCV tank(19) of second vehicle(18), the first and second vehicles(12,18) is stopped in refueling range of only one dispenser(5), including:

in case of a first refueling process,
acquiring first residual pressure of the first FCV tank(13) which is connected with the first refueling nozzle(11) and calculating sufficient conditions to achieve complete refueling of first vehicle (12);
using the conditions calculated by data processor (35) to decide and execute an optimized sequence that controls the compressor (2) and valves to reach within a minimum time the target pressure value(s)(TP) in the container(s) (1, 3, 4a, 4b, 4c) calculated by the data processor (35);
proceeding with refueling of first vehicle (12) when the conditions calculated by data processor (35) are met and provided that H₂ transfer with second nozzle (17) is already finished;

in case of the second refueling process,
acquiring second residual pressure of the second FCV tank(19) which is connected with the second refueling nozzle(17) and calculating sufficient conditions to achieve complete refueling of second vehicle (18);
using the conditions calculated by data processor (35) to decide and execute an optimized sequence that controls the compressor (2) and valves to reach within a minimum time the target pressure value(s) (TP) in the container(s) (1, 3, 4a, 4b, 4c) calculated by the data processor (35);
proceeding with refueling of second vehicle (18) when transfer of H₂ with first nozzle (11) is finished and when the conditions calculated by data processor (35) are met.

### BRIEF DESCRIPTION OF THE FIGURES

FIG. 1 illustrates an explanatory diagram showing a hydrogen refilling system according to Embodiment 1.

FIG. 2 illustrates an explanatory diagram showing lay-out of a hydrogen refilling system.

FIG. 3 illustrates an explanatory diagram showing another lay-out of a hydrogen refilling system.

FIG. 4 illustrates an explanatory flowchart showing a dispenser according to Embodiment 1.

FIG. 5A illustrates an explanatory diagram showing prior art process scheme of a hydrogen refilling system.

FIG. 5B illustrates an explanatory diagram showing prior art lay-out of a dispenser.

### DETAILED DESCRIPTION OF THE INVENTION

Several embodiments of the present invention will be explained below. The embodiments explained below are to explain one example of the present invention. The present invention is not limited to the following embodiments at all and includes various types of modifications carried out within a scope where the gist of the present invention is not changed. All of the configurations explained below are not necessarily essential configurations of the present invention.

### Embodiment 1

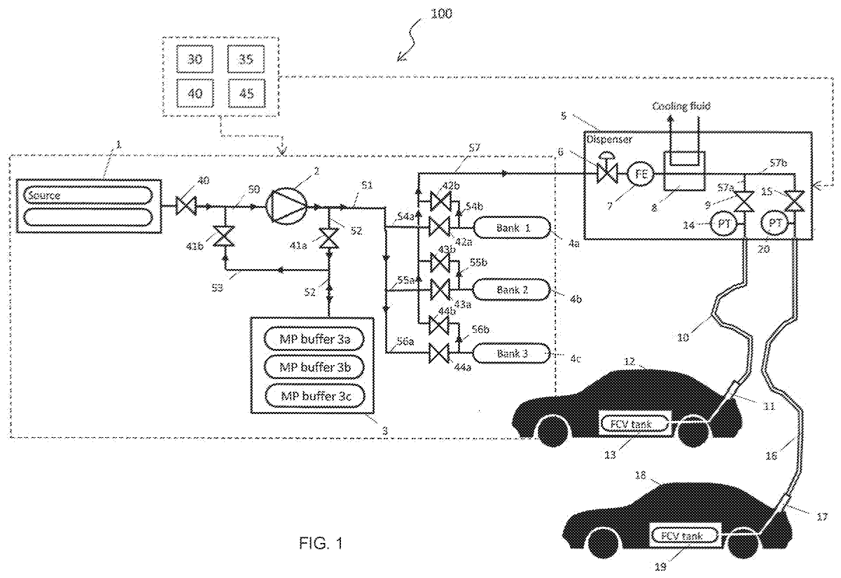

The hydrogen refueling system 1 of the first embodiment is explained by referring FIGS. 1 to 4. The hydrogen refueling system 100 includes a H₂ supply source 1, a compressor 2, MP buffers 3a, 3b, 3c, HP buffer banks 4a, 4b, 4c and a dispenser 5. The following is described in detail.

H₂ supply source 1 stores H₂ which has a first pressure.

The compressor 2 increases H₂ pressure and transfer H₂ from H₂ supply source 1 to MP buffers(3a, 3b, 3c), from H₂ supply source 1 to HP buffer banks(4a, 4b, 4c), or from MP buffers(3a, 3b, 3c) to HP buffer banks(4a, 4b, 4c) and/or the dispenser 5.

MP buffers (3a, 3b, 3c) store H₂ under a pressure which is higher than pressure of the H₂ supply source 1 and lower than the pressure of HP buffer banks(4a, 4b, 4c).

HP buffer banks(4a, 4b, 4c) store H₂ under various pressures which is higher than pressures of the H₂ supply source 1 and MP buffers(3a, 3b, 3c).

The dispenser 5 transfers H₂ from at least one container (e.g. H₂ supply source 1, MP buffers (3a, 3b, 3c), HP buffer banks(4a, 4b, 4c)) and/or from compressor discharge to the tank (13, 19) of a vehicle(12, 18).

The dispenser 5 includes only two H₂ refueling hoses 10, 16, only one H₂ flow control valve 6, only one H₂ cooling heat exchanger 8, and only one H₂ flow metering device 7.

The heat exchanger 8 cools down H₂ before being transferred to the tank (13, 19) of a vehicle (12, 18). The heat exchanger 8 is fed with a cooling fluid to cool down H₂. The heat exchanger 8 is placed downstream the metering device 7 on the main line 57.

The control valve(6) is placed on a main line 57 through which is sent the H₂ from the containers (1, 3a, 3b, 3c, 4a, 4b, 4c).

The metering device 7 is placed downstream the control valve 6 on the main line 57.

H₂ flow control valve 6 is controlled based on the filling protocol (e.g. by controlling pressure at the outlet of dispenser (5) to follow a predefined pressure ramp).

First and second branch lines 57a, 57b are branched from the main line 57 downstream the heat exchanger 8.

First on-off valve 9 is placed on the first branch line 57a. Second on-off valve 15 is placed on the second branch line (57b).

First hose 10 has a first refueling nozzle 11 at its one end part and is connected the first branch line 57a at its another end part. Second hose 16 has a second refueling nozzle 17 at its one end part and is connected the second branch line 57b at its another end part.

Dispenser 5 includes first and second interface 21, 22. The first interface 21 includes first payment interface, first ticket system, and first metering display. The second interface 22 includes second payment interface, second ticket system, and second metering display.

First controller 30 control the compressor 2 and one or more valve(s)(40, 41a, 41b, 41a, 43a, 44a) placed on pipes (50, 52, 53, 54a, 55a, 56a) in such a way that, when the station is idle (i.e. no vehicle is refueled or is waiting), depending on pre-determined operation steps, H₂ is transferred from one container (1, 3a, 3b, 3c, 4a, 4b, 4c) to another, up to pre-determined target pressure value(s) (Pₛₑₜ) in recipient containers (3a, 3b, 3c, 4a, 4b, 4c), for example, in the case there is one MP buffer, in one operation step controlled by first controller 30, H₂ is transferred from H₂ supply source 1 to MP buffers (3 (3a, 3b, 3c)) through the compressor 2 until the pressure in MP buffer 3 reaches a pre-determined target pressure which is higher than the pressure of the H₂ supply source 1, and in other operation steps controlled by first controller 30, H₂ is transferred from MP buffers (3 (3a, 3b, 3c)) to one HP buffer banks (4a, 4b, 4c) through the compressor 2 until the pressure in HP buffer banks (4a, 4b, 4c) reaches a pre-determined target pressure which is higher than the pressure in MP buffers (3(3a, 3b, 3c)).

The data processor 35 reads the residual pressure in the tank (13, 19) of the vehicle (12,18) when one vehicle (12,18) is connected to be re-fueled. The residual pressure is provided or measured by using nozzle IR communication device or pressure sensor (14, 20).

Depending on residual pressure in vehicle tank(13, 19), depending on pressure in the containers (1, 3a, 3b, 3c, 4a, 4b, 4c), and depending on ambient temperature, the data processor 35 calculates target pressure value(s) (TP) in one or several container(s) (1, 3a, 3b, 3c, 4a, 4b, 4c) optimized to be sufficient to achieve complete refueling of connected vehicle (12,18).

The heat exchanger 8 being present, data processor 35 may as well calculate depending on residual pressure in vehicle tank (13, 19), depending on quantity of H₂ refueled in previous vehicle and depending on ambient temperature, sufficient conditions to achieve refueling of connected vehicle according to low H₂ temperature refueling protocol, such as minimum time interval with previous vehicle or maximum temperature of the heat exchanger (8).

The second controller 40, when one vehicle (12,18) is connected to be re-fueled, uses the conditions calculated by the data processor 35 to decide and execute an optimized sequence that controls the compressor 2 and valves to reach target pressure value(s) (TP) in the container(s) (1, 3a, 3b, 3c, 4a, 4b, 4c) calculated by the data processor 35.

The optimized sequence is decided in such a way that the time for being able to reach the conditions calculated by the data processor 35 after connecting a refueling nozzle (11, 17) to the vehicle is a minimum time.

This minimum time is zero when sufficient conditions to achieve complete refueling of connected vehicle are already met when the refueling nozzle (11, 17) is connected to the vehicle. Third controller 45 , when the conditions calculated by the data processor 35 are met, controls the compressor 2 and valves (40, 41a, 41b, 41a, 42b, 43a, 43b, 44a, 44b, 6, 9, 15) according to a pre-determined strategy and filling protocol, in such a way that H₂ is transferred from at least one container (1, 3a, 3b, 3c, 4a, 4b, 4c) to the tank (13, 19) of the vehicle (12, 18). The first controller 30 and the second controller 40 may control one or more valves (40, 41a, 41b, 41a, 43a, 44a) which are placed on pipes(50, 52, 53, 54a, 55a, 56a) in order to transfer H₂ from one container (1, 3, 4a, 4b, 4c) to another, either directly or through the compressor 2.

Target pressure values(TP) in the containers (3a, 3b, 3c, 4a, 4b, 4c) calculated by the data processor 35 may be lower than the pre-determined target pressure value (Pₛₑₜ) in each recipient container (3a, 3b, 3c, 4a, 4b, 4c) used by first controller 30. In addition, target pressure values (TP) in HP buffer banks(4a, 4b, 4c) calculated by the data processor 35 may be the same value for all HP buffer banks or different values.

Based on a container order(HP buffer bank 4a, then HP buffer bank 4b, then HP buffer bank 4c) that may be calculated depending on remaining pressure in the containers (3a, 3b, 3c, 4a, 4b, 4c), the third controller 45 may control valves (42b, 43b, 44b, 6, 9, 15) to connect one of the containers (4a, 4b, 4c) to the FCV tank(13, 19) and then to refuel H₂ into the FCV tank by balancing pressures between the connected container and the FCV tank (13, 19), and then, after disconnecting the used container, to connect another of the containers (4a, 4b, 4c) to the FCV tank (13, 19) and then to refuel H₂ into the FCV tank (13, 19) by balancing pressures between the connected container and the FCV tank (13, 19). And then, the sequence may be repeated with other containers (4a, 4b, 4c), depending on a pre-defined strategy. For example, the containers order may be calculated to connect first the container having the lowest remaining pressure, and then follow the order of increasing remaining pressure in the containers used to refuel H₂.

When refueling H₂ into the FCV tank (13, 19) by switching between containers, balancing pressures between the connected container and the FCV tank (13, 19) may be partial. Changing to the next container may be made when there is still a large pressure difference between the connected container (4a, 4b, 4c) and the FCV tank (13, 19), for example when the refueling flow rate required by fueling protocol cannot be maintained, due to the flow restrictions between the connected container (4a, 4b, 4c) and the FCV tank (13, 19).

The third controller 45 may control first refueling process which is configured to refuel the H₂ through the first hose 10 from the first refueling nozzle 11 into first FCV tank 13 of first vehicle 12. The third controller 45 may control second refueling process which is configured to refuel the H₂ through the second hose 16 from the second refueling nozzle 17 into second FCV tank 19 of second vehicle 18.

In case of a first refueling process, the data processor 35 may acquire first residual pressure of the first FCV tank 13 which is connected with the first refueling nozzle 11 and may calculate sufficient conditions to achieve complete refueling of first vehicle 12. The second controller 40 may use the conditions calculated by data processor 35 to decide and execute an optimized sequence that controls the compressor 2 and valves to reach within a minimum time the target pressure value(s) (TP) in the container(s) (3a, 3b, 3c, 4a, 4b, 4c) calculated by the data processor 35. when the conditions calculated by data processor 35 are met, third controller 45 may proceed with refueling of first vehicle 12.

In case of the second refueling process, the data processor 35 may acquire second residual pressure of the second FCV tank 19 which is connected with the second refueling nozzle 17 and calculate sufficient conditions to achieve complete refueling of second vehicle 18. The second controller 40 may use the conditions calculated by data processor 35 to decide and execute an optimized sequence that controls the compressor 2 and valves to reach within a minimum time the target pressure value(s) (TP) in the container(s) (3a, 3b, 3c, 4a, 4b, 4c) calculated by the data processor 35. When transfer of H₂ with first nozzle (11) is finished and when the conditions calculated by data processor 35 are met, third controller 45 may proceed with refueling of second vehicle 18.

The first residual pressure may be measured by first pressure sensor 14 which is placed downstream the first on-off valve 9 on the first branch line 57a. The second residual pressure may be measured by second pressure sensor 20 which is placed downstream the second on-off valve 15 on the second branch line 57b.

The third controller 45 may control temperature and/or flow rate of cooling fluid which is sent to the heat exchanger 8 to control temperature of the H₂ which is refueled into the FCV tank.

The second controller 40 may calculate an expected waiting time which is period for being able to start refueling process from after completing payment initiation or after connecting the nozzle to the first or second FCV tank and output the expected waiting time to output device. The second controller 40 may calculate an expected complete time which is period for completing refueling process from after completing payment initiation or after connecting the nozzle to the first or second FCV tank and output the expected complete time to output device. The output device is for example, display, speaker, another computer, server, memory.

### Method for Embodiment 1

The method for performing first refueling process which refuels H₂ to first FCV tank 13 of first vehicle 12 and second refueling process which refuels H₂ to second FCV tank 19 of second vehicle 18, the first and second vehicles (12,18) being stopped in refueling range of only one dispenser 5, includes the following steps;

in case of a first refueling process, step of acquiring first residual pressure of the first FCV tank 13 which is connected with the first refueling nozzle 11 and calculating sufficient conditions to achieve complete refueling of first vehicle 12, step of using the conditions calculated by data processor (35) to decide and execute an optimized sequence that controls the compressor 2 and valves to reach within a minimum time the target pressure value(s) (TP) in the container(s) (3a, 3b, 3c, 4a, 4b, 4c) calculated by the data processor 35, step of proceeding with refueling of first vehicle 12 when the conditions calculated by data processor 35 are met, provided that H₂ transfer with second nozzle (17) is already finished,

in case of the second refueling process, step of acquiring second residual pressure of the second FCV tank 19 which is connected with the second refueling nozzle 17 and calculating sufficient conditions to achieve complete refueling of second vehicle 18, step of using the conditions calculated by data processor 35 to decide and execute an optimized sequence that controls the compressor 2 and valves to reach within a minimum time the target pressure value(s) (TP) in the container(s) (3a, 3b, 3c, 4a, 4b, 4c) calculated by the data processor 35, step of proceeding with refueling of second vehicle 18 when transfer of H2 with first nozzle (11) is finished and when the conditions calculated by data processor 35 are met.

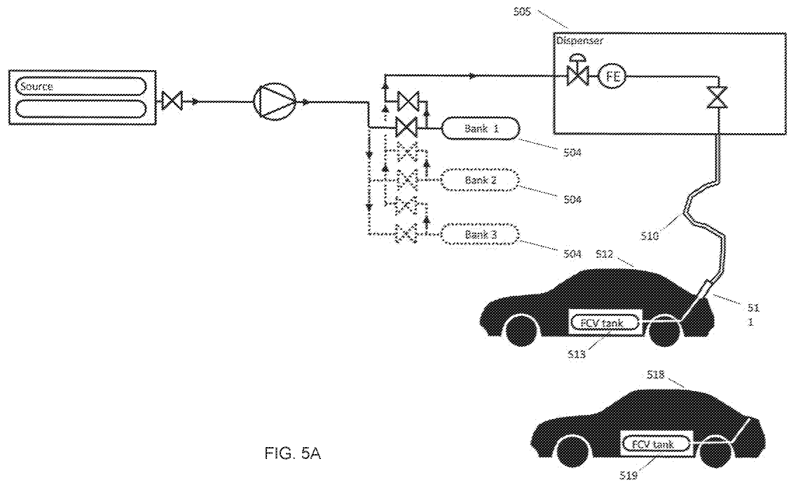

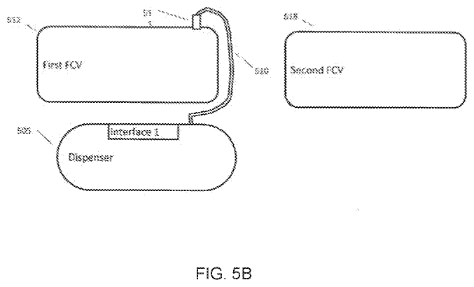

FIG. 4 shows flowchart of Embodiment 1. The first refueling process of first FCV 12 is indicated on step 1 to step 8 and on transition 1 to transition 9, and the second refueling process of second FCV 18 is indicated on step 11 to step 18 and on transition 11 to transition 19. Transitions indicate conditions to go from one step to the next one.

Transition 1: first FCV 12 arrives or is already waiting.

In step 1, first FCV 12 is positioned within the range of the first hose 10.

Transition 2: first FCV 12 positioned.

In step 2, first FCV 12 customer initiates payment by card (if applicable) using the first payment interface in first interface 21.

Transition 3: payment initiation completed.

In step 3, customer or operator connects the first refueling nozzle 11 to the first FCV 12.

Transition 4: nozzle 11 connected to the first FCV tank 13.

In step 4, pressure in the tank 13 of the first FCV 12 is read by IR communication device or by the pressure sensor 14. Depending on the value, the controller calculates the sufficient pressures in HP buffer banks and/or MP buffers (if any) to achieve successful refueling of the first FCV 12 tank starting with actual tank 13 pressure.

Transition 5: HP buffer banks and/or MP buffers (if any) have been refilled up to the calculated values. Before proceeding step 5, it is also checked that refueling with second hose 16 is not on-going (i.e. second refueling is not in step 15).

In step 5, first on-off valve 9 is opened, second on-off valve 15 is closed, first FCV 12 starts refueling. Refueling quantity is shown on the first metering display in first interface 21.

Transition 6: refueling with first hose (10) terminated.

In step 6, customer or operator disconnects the first nozzle 11 and place it back on the dispenser 5.

Transition 7: the first nozzle 11 placed back on dispenser 5.

In step 7, first FCV 12 customer proceeds to payment using the first payment interface in first interface 21, and first metering display in first interface 21.

Transition 8: payment completed.

In step 8, first FCV 12 is moved out of the dispenser 5 area.

Transition 9: first hose 10 of dispenser 5 area cleared. It is returned to check condition of transition 1. Until a new FCV arrives, first refueling is idle.

Transition 11: second FCV 18 arrives or is already waiting.

In step 11, second FCV 18 is positioned within the range of the second hose 16.

Transition 12: second FCV 18 positioned.

In step 12, second FCV 18 customer initiates payment by card (if applicable) using the second payment interface in second interface 22.

Transition 13: payment initiation completed.

In step 13, customer or operator connects the second refueling nozzle 17 to the second FCV 18.

Transition 14: second refueling nozzle 17 connected to second FCV tank 19.

In step 14, pressure in the tank 19 of the second FCV 18 is read by IR communication device or by the pressure sensor 20. Depending on the value, the controller calculates the sufficient pressures in HP buffer banks and/or MP buffers (if any) to achieve successful refueling of the second FCV 18 tank starting with actual tank 19 pressure.

Transition 15: HP buffer banks and/or MP buffers (if any) have been refilled up to the calculated values. Before proceeding step 15, it is also checked that refueling with first hose 10 is not on-going (i.e. first refueling is not in step 5).

In step 15, second on-off valve 15 is opened, first on-off valve 9 is closed, and second FCV 18 starts refueling. Refueling quantity is shown on the second metering display in second interface 22.

Transition 16: refueling with second hose 16 terminated. In step 16, customer or operator disconnects the second nozzle 17 and place it back on the dispenser 5.

Transition 17: nozzle 17 placed back on dispenser 5.

In step 17, the second FCV 18 customer proceeds to payment using the second payment interface in second interface 22, and second metering display in second interface 22.

Transition 18: payment completed.

In step 18, the second FCV 18 is moved out of the dispenser 5 area.

Transition 19: second hose 16 area of dispenser 5 cleared. It is returned to check condition of transition 11. Until a new FCV arrives and first hose area already occupied, second refueling is idle.

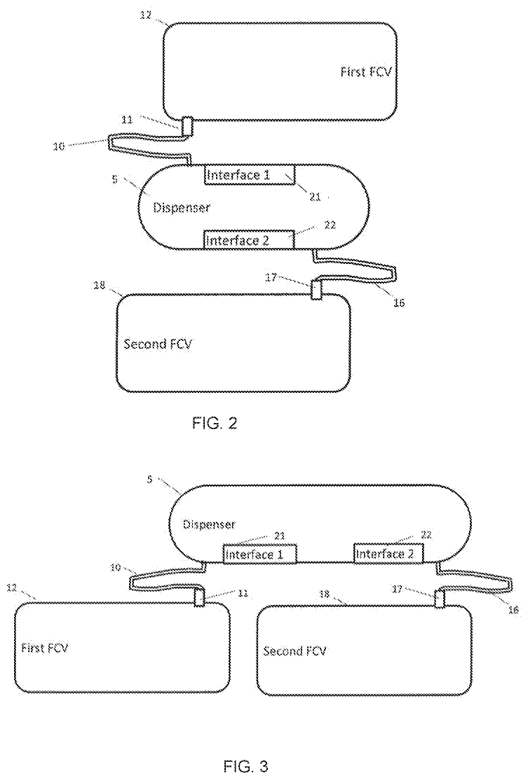

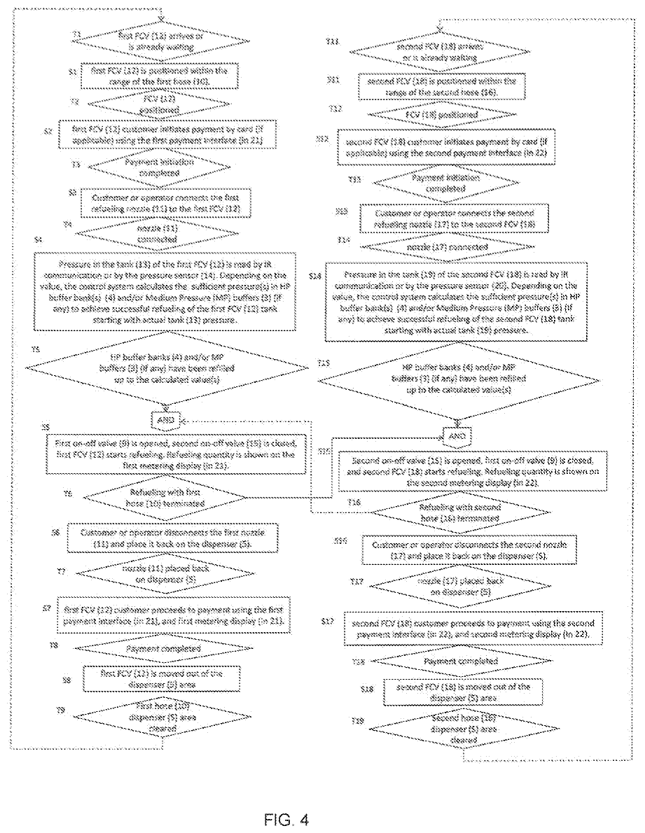

FIGS. 2 and 3 show a different type of layout of first and second interface 21, 22 in dispenser 5.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-7. (canceled)

8. A hydrogen refueling system comprising:
at least one H₂ supply source that stores H₂ which has a first pressure;
compressor that is able to increase H₂ pressure and which can transfer H₂ from one container or the H₂ supply source to another at least one container;
one or several high pressure buffer bank(s) that store H₂ under pressures higher than a pressure of the H₂ supply source;
optionally, one or more medium pressure buffer(s) that store H₂ under a pressure higher than the pressure of the H₂ supply source and lower than the pressure of said one or several high pressure buffer bank(s);
at least one dispenser, which can transfer H₂ to a tank of a vehicle, from at least one container that is selected from one or more of the H₂ supply source, the optional one or more medium pressure buffer(s), said one or several high buffer bank(s), and a discharge of the compressor;
optionally, one heat exchanger which can cool down H₂ before being transferred to the tank of the vehicle, said optional one heat exchanger being fed with a cooling fluid;
a first controller that controls the compressor and one or more valve(s) placed on pipe(s) in such a way that, when said hydrogen refueling system is idle, H₂ is transferred from one or more of the H₂ supply source, the optional one or more MP buffer(s), and said one or several high pressure buffer tank(s) to one or more of the optional one or more medium pressure buffer(s) and said one or more several buffer tank(s) up to a pre-determined target pressure value or values (Pₛₑₜ);
a data processor that, when one vehicle is connected to said at least one dispenser to be re-fueled, reads a residual pressure in the tank of the vehicle using a nozzle IR communication device or pressure sensor and calculates a target pressure value or values in at least one of the H₂ supply source, the optional one or more medium pressure buffer(s), and said one or several high pressure buffer tank(s) which are sufficient to achieve complete refueling of connected vehicle, wherein said target pressure value or values is/are calculated by said data processor depending on: a) the residual pressure in vehicle tank, b) a pressure in one or more of the H₂ supply source, the optional one or more medium pressure buffer(s), and said one or several high pressure buffer tank(s), and/or c) the ambient temperature of said system;
a second controller that, when one vehicle is connected to said at least one dispenser be re-fueled, uses said target pressure value or values to decide and execute a sequence that controls the compressor and valve(s) to reach said target pressure value or values;
a third controller that, when the target pressure value or values calculated by the data processor are met through control of the compressor and valve(s) via execution of said sequence by the second controller, controls the compressor and valve(s) according to a pre-determined filling protocol in such a way that H₂ is transferred, to the tank of the vehicle, from one or more of the H₂ supply source, the optional one or more medium pressure buffer(s), and said one or several high pressure buffer tank(s).

9. The system according to claim 8, wherein said sequence is decided in such a way that a time for being able to reach said target pressure value or values after connecting a refueling nozzle to the vehicle is minimized.

10. The system of claim 8, wherein said at least one dispenser comprising: a control valve that is placed on a main line through which is sent the H₂ from the containers; a metering device that is placed on the main line; a heat exchanger that is placed on the main line that cools or warms the H₂ through the main line; first and second branch lines that are branched from the main line; a first on-off valve that is placed on the first branch line; a second on-off valve that is placed on the second branch line; first hose that has a first refueling nozzle at its one end part and is connected the first branch line at its another end part; and a second hose that has a second refueling nozzle at an end thereof and which is connected to the second branch line at an another end thereof.

11. The system of claim 8, wherein:
the third controller can control a first refueling process which is configured to refuel the H₂ through the first hose from the first refueling nozzle into a FCV tank of a first vehicle, and/or a second refueling process which is configured to refuel the H₂ through the second hose from the second refueling nozzle into a FCV tank of a second vehicle;
in the case of the first refueling process,
the data processor can acquire a first residual pressure of the FCV tank of the first vehicle which is connected with the first refueling nozzle and can calculate conditions sufficient to achieve complete refueling of the first vehicle;
the second controller can use the conditions calculated by the data processor to decide and execute a sequence that controls the compressor and valve(s) to reach said target pressure value or values, and
when the conditions calculated by the data processor are met, and provided that H₂ transfer with the second nozzle is already finished, a third controller can proceed with refueling of the first vehicle; and
in case of the second refueling process,
the data processor can acquire a second residual pressure of the FCV tank of the second vehicle which is connected with the second refueling nozzle and calculate conditions sufficient to achieve complete refueling of the second vehicle,
the second controller can use the conditions calculated by data processor to decide and execute a sequence that controls the compressor and valves to reach said target pressure value or values, and
when transfer of H₂ with the first nozzle is finished and when the conditions calculated by the data processor are met, a third controller can proceed with refueling of the second vehicle.

12. A method for using only one H₂ dispenser having first and second refueling nozzles for connection to respective first and second FCV tanks of respective first and second vehicles to perform a first refueling process which refuels the first FCV tank with H₂ and a second refueling process which refuels the second FCV tank, each of the first and second vehicles being stopped in a refueling range of said only one H₂ dispenser, said method comprising the steps of:
for said first refueling process:
acquiring a first residual pressure of the first FCV tank which is connected to the first refueling nozzle and calculating conditions with a data processor that are sufficient to achieve complete refueling of first FCV tank,
using the calculated conditions to decide and execute a sequence that controls a compressor and valves to reach a target pressure value or values in at least one of a H₂ supply source, one or more medium pressure buffers, and one or more high pressure buffer tanks, and
proceeding with the refueling of the first vehicle when the calculated conditions are met, provided that H₂ transfer to the second FCV tank with the second nozzle is already finished;
in case of the second refueling process,
acquiring a second residual pressure of the second FCV tank which is connected to the second refueling nozzle and calculating conditions sufficient to achieve complete refueling of the second FCV tank;
using the calculated conditions to decide and execute a sequence that controls the compressor and valves to reach the target pressure value or values in at least one of the H₂ supply source, the one or more medium pressure buffers, and the one or more high pressure buffer tanks;
proceeding with the refueling of the second vehicle when transfer of H₂ with the first refueling nozzle is finished and when the conditions calculated by data processor are met.
